(19) United States
(12) Patent Application Publication
(10) Pub. No.: US 2025/0225804 A1
(43) Pub. Date: Jul. 10, 2025

(54) METHOD OF EXTRACTING INFORMATION FROM AN IMAGE OF A DOCUMENT

(71) Applicant: FUSEMACHINES, INC., New York, NY (US)

(72) Inventors: Mahendra Singh Thapa, Kathmandu (NP); Miran Ghimire, Kathmandu (NP); Suresh Manandhar, Kathmandu (NP); Kiran Prajapati, Kathmandu (NP); Roshani Acharya, Kathmandu (NP); Purushottam Shrestha, Kathmandu (NP); Aashish Pokharel, Kathmandu (NP)

(21) Appl. No.: 18/732,252

(22) Filed: Jun. 3, 2024

Related U.S. Application Data
(60) Provisional application No. 63/470,334, filed on Jun. 1, 2023.

(51) Int. Cl. G06V 30/19; G06F 16/953; G06F 40/143; G06F 40/166; G06F 40/51; G06F 40/58; G06V 10/82; G06V 30/146; G06V 30/16; G06V 30/22; G06V 30/41

(52) U.S. Cl. CPC G06V 30/19127; G06F 16/953; G06F 40/143; G06F 40/166; G06F 40/51; G06F 40/58; G06V 10/82; G06V 30/147; G06V 30/1607; G06V 30/19013; G06V 30/22; G06V 30/41

(57) ABSTRACT

The present disclosure provides a method of extracting information from an image of a document in which the document image is properly aligned to be processed, the regions containing the desired information are detected and extracted from the document image, a text machine-learning model is performed in which the handwritten text in multiple languages may be extracted and stored, and a user may review, edit, and translate the extracted information to create a standardized digital format of the information contained in the document.

### CROSS-REFERENCE TO RELATED APPLICATIONS

The present patent application claims the priority benefit of U.S. provisional patent application 63/470,334 filed Jun. 1, 2023, the disclosure of which is incorporated herein by reference.

### BACKGROUND OF THE DISCLOSURE

### 1. Field of the Disclosure

The present disclosure is generally related to extracting information from an image of a document.

### 2. Description of the Related Art

Currently, there are many challenges with extracting information from an image of a document, such as formatting issues of non-standard documents that have been captured or scanned from an angle, and poor image quality may lead to inaccurate information being extracted. Also, handwritten text can be difficult to recognize accurately because it may be written messy, in cursive, or may be difficult to distinguish between handwritten text or print text. Lastly, documents that contain multiple languages can pose a challenge for information extraction. Different languages may require different recognition algorithms; if the language is unknown, it can be difficult to extract information accurately. Thus, there is a need in the prior art to improve methods of extracting information from an image of a document.

### SUMMARY OF THE CLAIMED INVENTION

The present disclosure provides a method of extracting information from an image of a document in which the document image is properly aligned to be processed, the regions containing the desired information are detected and extracted from the document image, a text machine-learning model is performed in which the handwritten text in multiple languages may be extracted and stored, and a user may review, edit, and translate the extracted information to create a standardized digital format of the information contained in the document.

### BRIEF DESCRIPTIONS OF THE DRAWINGS

FIG. 1 illustrates an example system for performing a method of extracting information from an image of a document.

FIG. 2 illustrates an example workflow performed by an extraction managing module.

FIG. 3 illustrates an example workflow performed by an alignment module.

FIG. 4 illustrates an example workflow performed by a region module and a text module.

FIG. 5 illustrates an example workflow performed by a review module.

FIG. 6 illustrates an example of computing system.

FIG. 7 illustrates an example neural network architecture.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

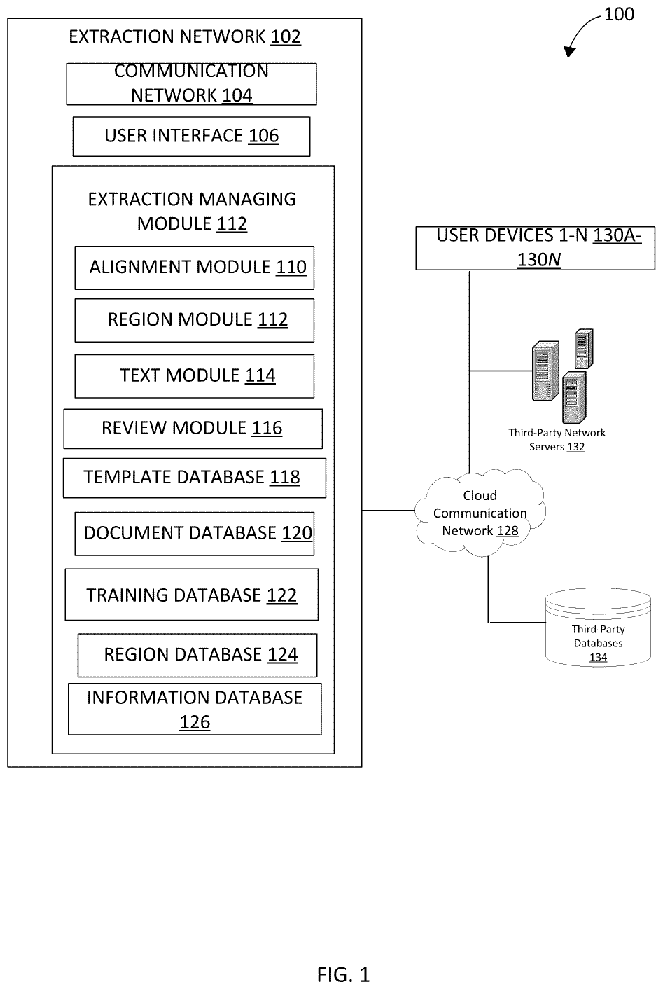

FIG. 1 illustrates an example system for performing a method for extracting information from an image of a document.

This method comprises an extraction network 102 which may receive or contain an uploaded document that requires extraction of information from the image of the document. The extraction network 102 may include a communication interface 104 to receive images of the documents from a plurality of sources that can connect to the network, a user interface 106 which allows a user of the extraction network 102 to review the extracted information as well as translate the language that was extracted from the document, an extraction managing module 108, alignment module 110, region module 112, text module 114 and review module 116 that provides the process of aligning the document for the extraction process, determine the regions of interest of the document, extract the text from the document including extracting handwritten text, and allow a user to review and translate the extracted text from the document on a user interface 106 to store the extracted information for a company's internal processes.

In some embodiments, the documents may be banking or finance, healthcare, legal, real estate, human resource, etc. For example, the documents may include bank statements, tax returns, ID proof, medical records, patient information documents, contracts, court documents, legal briefs, lease agreements, property deeds, mortgage documents, resumes, certificates, references, etc. In some cases, the extraction network 102 may include a communication interface 104, which may be a wired and/or wireless network. The communication interface 104, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication interface 104 may allow ubiquitous access to shared pools of configurable system resources and higher-level services that can be rapidly provisioned with minimal management effort, often over the Internet, and relies on sharing of resources to achieve coherence and economies of scale, like a public utility, while third-party clouds enable organizations to focus on their core businesses instead of expending resources on computer infrastructure and maintenance.

In some cases, the extraction network 102 may include a user interface(s) 106, which may either accept inputs from users or provide outputs to the users or may perform both actions. In some cases, a user can interact with the user interface(s) 106 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the user interface(s) 106 may either be implemented as a Command Line Interface (CLI), a Graphical User Interface (GUI), a voice interface, or a web-based user interface. In some cases, the extraction network 102 may include an extraction managing module 108, which may begin by sending a query to the document database 120 for a new data entry.

The extraction managing module 108 may extract the document from the document database 120. The extraction managing module 108 may extract the reference document from the template database 118. The extraction managing module 108 may send the document and the reference document to the alignment module 110. The extraction managing module 108 may initiate the alignment module 110, the region module 112, the text module 114, and the review module 116 to extract, review, and translate the information from the document. In some cases, the extraction network 102 may include an alignment module 110, which may begin by being initiated by the extraction managing module 108. The alignment module 110 may receive the document and the reference document from the extraction managing module 108. The alignment module 110 may train the alignment machine-learning model. The alignment module 110 may deploy the alignment machine-learning model on the document. The alignment module 110 may send the image to the region module 112. The alignment module 110 may return to the extraction managing module 108.

In some cases, the extraction network 102 may include a region module 112, which may begin by being initiated by the extraction managing module 108. The region module 112 may receive the image from the alignment module 110. The region module 112 may extract the reference coordinates from the template database 118. The region module 112 may compare the reference coordinates to the image. The region module 112 may extract the relevant information from the image. The region module 112 may store the relevant information in the region database 124. The region module 112 returns to the extraction managing module 108.

In some cases, the extraction network 102 may include a text module 114, which may begin by being initiated by the extraction managing module 108. The text module 114 may extract a first information data entry from the region database 124. The text module 114 may deploy the text machine-learning model on the information data entry. The text module 114 may store the data in the information database 126. The text module 114 may determine if more information data entries are stored in the region database 124. If it is determined that more information data entries remain in the region database 124, the text module 114 may extract the next information data entry from the region database 124.

The process may return to performing the text machine-learning model on the extracted information data entry. If it is determined that there are no more information data entries remaining in the region database 124, the text module 114 may return to the extraction managing module 108. In some cases, the extraction network 102 may include a review module 116, which may begin by being initiated by the extraction managing module 108. The review module 116 may extract the first data entry from the information database 126. The review module 116 may display the text on the user interface 106. The review module 116 may determine if the user selected to translate the text. If it is determined that the user selected to translate the text, the review module 116 may translate the text. The review module 116 may display the translated text on the user interface 106.

If it is determined that the user did not select to translate or after the text has been translated and displayed on the user interface 106, the text in the review module 116 may determine if the user selected to edit the text. If it is determined that the user selected to edit the text, the text module 116 may store the edits in the information database 126. If it is determined that the user did not select to edit the text, the text module 116 may determine if there are more data entries remaining in the information database 126. If it is determined that there are more data entries remaining in the information database 126, the text module 116 may extract the next data entry stored in the information database 126, and the process may return to displaying the text on the user interface 106. If it is determined that there are no more data entries remaining in the information database 126, the text module 116 returns to the extraction managing module 108.

In some cases, the extraction network 102 may include a template database 118, which may contain the templates used in the process described in the extraction managing module 108, the alignment module 110, and region module 112. The database may contain a company ID, a company name, a form name, a template document, and reference coordinates for the template. The company ID may be used to identify each company with a unique ID number. The company name may be the name of each company using the form. The form name may be the form the company uses, for example, loan applications, medical records releases, retainer agreements, home sales contracts, employee expense reports, etc. The template document may be a link to the template document the company should use for the form. The template document may be a pre-designed form that includes all the necessary fields and information for the specific form.

The reference coordinates may be specific points or coordinates on the template or template image that are used as reference points to identify and extract specific regions or fields of interest from the document. The reference coordinates may be coordinates or markers that can be used to identify and locate specific regions of the document. In some embodiments, the reference coordinates may be defined by the extraction network 102, a user of the extraction network 102, or by the company and may be based on the layout and structure of the document. For example, during document processing using the template with the reference coordinates, the document processing software may use these coordinates as reference points to identify and extract the data corresponding to specific fields or regions of the document. For example, if a template has reference coordinates for a customer's name and address, the document processing software can use these reference coordinates to locate and extract the corresponding data from the document.

In some embodiments, the template may be stored on the extraction network 102 as a data file, such as a Word document, pdf document, text file, image, etc. In some embodiments, the database may include a form ID which may allow the extraction network 102 to identify the template required for the information extraction process. In some cases, the extraction network 102 may include a document database 120, which may contain the information data required to be extracted by the extraction network 102. The document may be uploaded through a user device 130 to the extraction network 102. The database may contain the user that uploaded the document, a user ID, the company ID that the document is for, the type of document that was uploaded, the image of the document, etc. The user ID may be a unique identifier, such as a unique number associated with the user. The company ID may be used to identify each company with a unique ID number. The company name may be the name of each company using the form. The form name may be the form the company uses, for example, loan applications, medical records releases, retainer agreements, home sales contracts, employee expense reports, etc. The image of the document may be stored as a data file on the extraction network 102 and may be an image scanned or taken by a device, such as a smartphone or tablet.

In some embodiments, the database may include a form ID which may allow the extraction network 102 to identify the template required for the information extraction process. In some cases, the extraction network 102 may include a training database 122, which may contain data to train the alignment machine-learning model as described in the alignment module 110 and the text machine-learning model as described in the text module 116. For example, the database may contain the data to pre-trained the alignment machine-learning model with a DVQA dataset, fed learnable embedding as input to the decoder layer. The dataset is used for training and testing computer vision and question-answering models. The DVQA dataset for training the alignment machine-learning model consists for single page document containing letters, memos, notes, reports etc.

For example, the text machine-learning model may be trained using an IAM dataset which may be a dataset consisting of forms filled out by over 600 writers, with a total of over 115,000 isolated and labeled words. The forms include a variety of text types, including personal letters, postcards, and telegrams, as well as forms used in administrative and business contexts. For example, supervised learning may be used to train the text machine-learning model, where the model is trained to predict the correct label, for example, the text, given an input image of handwriting.

For example, the training process may be preprocessing the images, such as normalizing the contrast, resizing the images to a standard size, and segmenting the images into individual words or text lines. The preprocessed images, such as a convolutional neural network, are then used to train the machine learning model. For example, the model may be presented with a batch of training images and corresponding labels. The model generates a prediction for each input image compared to the true label. The difference between the predicted and true label, the loss, is calculated, and the model weights are adjusted using backpropagation to minimize the loss.

This process may be repeated for many iterations over the entire training set until the model may deploy satisfactorily on a validation set. In some embodiments, the text machine-learning model may be trained on a plurality of languages using similar datasets such as CEDAR, Chinese and English Document Analysis and Recognition, a dataset that contains handwritten Chinese and English characters and words, and printed text. RIMES, Repository of Images and MAnuscriptS, is a dataset that contains handwritten and printed text in several European languages, including French, German, and English. CVL, Chars74K, and Street View Text, a dataset that contains handwritten characters and digits from several languages, including English, French, German, and Italian. Arabic Handwriting Recognition Dataset which contains handwritten Arabic text. Hindi Handwriting Dataset which contains handwritten Hindi characters and words.

In some embodiments, the training database 122 may contain the data to train the translation machine-learning model as described in the review module 116. For example, a translation machine-learning process may be used to preprocess the input text to remove unnecessary characters, convert the text to lowercase, and split the text into sentences or paragraphs. The text is split into individual words or tokens, which are used as the input to the translation machine-learning model. A translation machine-learning model may be used to translate the source language text to the target language. The translation machine-learning may be performed through rule-based translation, statistical translation machine-learning, neural translation machine-learning, etc. The translated text is post-processed to correct any grammatical errors or inconsistencies and ensure that the translated text is fluent and natural sounding in the target language.

In some cases, the extraction network 102 may include a region database 124, which contains the data that is associated with the reference points that correspond to the specific fields or regions on the document. The region database 124 may contain the type of document, an ID for the document, the field or region of the document, the extracted data from the document, etc. In some embodiments, the database may contain the name or user ID of whose information is in the document, the name or user ID of the user that uploaded the document, the company ID or company name that the document is for, etc.

For example, the region module may extract the reference coordinates from the template database 118 by receiving the type of document that was extracted from the document database 120 in the process described in the alignment module 110. For example, during document processing using the template with the reference coordinates, the document processing software may use these coordinates as reference points to identify and extract the data corresponding to specific fields or regions of the document. For example, if a template has reference coordinates for a customer's name and address, the document processing software can use these reference coordinates to locate and extract the corresponding data from the document. In some embodiments, the region module 112 may receive the reference document data from the alignment module 110.

In some cases, the extraction network 102 may include an information database 126 containing the data extracted from the document image described in the text module 114 and the edited information described in the review module 116. The database may contain the document image, the image of each region of interest from the document, the extracted text from the corresponding region of interest, the language the extracted text is in, etc. For example, the output of the text machine-learning model which may be the key-value pair for the text and the associated translation of the text. For example, the key-value pair may be a fundamental data structure consisting of a unique identifier, the key, and an associated value. The key serves as a reference to the value, allowing it to be easily retrieved or updated. Key-value pairs, such as databases and key-value may store, are commonly used in data storage and retrieval systems.

The database may store data regarding text characters, document alignment, document structure, and table structure. Such data may include contain text characters extracted from the image. The text characters may be in a plurality of languages for an individual document. For example, the text machine-learning model can detect, recognize, and extract handwritten text in a plurality of languages contained in a single document image, and the extracted data may be stored in the information database 126. In some embodiments, the database may contain a document ID, user ID, company ID, etc., for the users of the extraction network 102 to extract the data stored in the information database 126.

A machine learning model may be trained on datasets that include multiple documents in relation to mask image modeling tasks with specific architectures. Such a machine learning model may include feature extraction architecture and detection frameworks associated with object detection. The machine learning model may convert a document image into input patches and passes it into the vanilla transformer. The extracted output features are then passed into the detection framework to identify the correct labels (e.g., caption, footnote, formula, list item, page footer, page header, picture, section header, table, text, title, handwriting, and stamp). Machine learning models for table structure recognition may include transformer encoder decoder architecture that predicts the location of an object and the class of the object.

In some embodiments, the database may contain the plurality of texts for each of the documents that correspond to the region of interest the text was extracted from the document image. In some embodiments, the data contained in the database may be the image of the region of interest from the uploaded document image and the extracted text from the text machine-learning model performed by the text module 116. In some embodiments, if the user edited the text on the user interface 106, the edited text is stored in the information database 126 to ensure that the corrected information is saved on the extraction network 102. In some embodiments, the edited data may be stored in the training database 122 to further train the model, such as the text or translation machine-learning models.

In some cases, the extraction network 102 may include a cloud 128, which is a distributed network of computers comprising servers and databases. A cloud 128 may be a private cloud 128, where access is restricted by isolating the network, such as preventing external access, or by using encryption to limit access to only authorized users. Alternatively, a cloud 128 may be a public cloud 128 where access is widely available via the Internet. A public cloud 128 may not be secured or may include limited security features.

In some cases, the extraction network 102 may include a plurality of user devices 1-N 130, which may be a desktop computer, laptop computer, tablet, smartphone, other portable computing device, etc. The user device 130 may be used by individuals to access and interact with a software application, data, and other resources hosted on a network or server. A user device 130 may be any device that provides an interface between a user and a computer system or network. This interface may include hardware components such as a display, keyboard, mouse, or touchpad and software applications allowing users to perform tasks and access information. User devices 130 may also include built-in sensors such as cameras, microphones, or GPS modules, enabling the device to collect data and interact with the environment differently.

In some embodiments, a user device 130 may also have a unique identifier or address that allows it to be recognized and tracked on a network. This identifier may be a hardware-specific identifier, such as a MAC address or a software-specific identifier, such as an IP address. The user devices 130 may be used to upload or send an image of a document to the extraction network 102 to extract the data contained in the document in provide the information extracted in a digital format back to the user device 130. A user may access the extraction network 102 to collect the processed document image for further internal processing. In some embodiments, the documents may be banking or finance, healthcare, legal, real estate, human resource, etc. For example, the documents may include bank statements, tax returns, ID proof, medical records, patient information documents, contracts, court documents, legal briefs, lease agreements, property deeds, mortgage documents, resumes, certificates, references, etc.

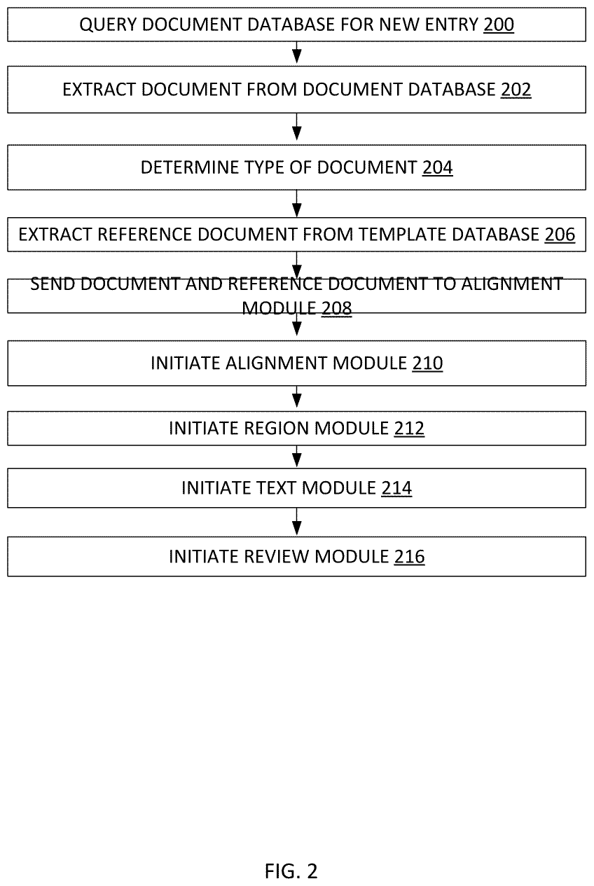

FIG. 2 illustrates an example workflow performed by the extraction managing module 108. The process may begin with the extraction managing module 108 sending, at step 200, a query to the document database 120 for a new data entry. For example, the extraction managing module 108 may send a query to the document database to determine if a new document image has been stored, and if so, the extraction managing module may extract the document image from the document database 120. The extraction managing module 108 may extract, at step 202, the document from the document database 120. For example, the extraction managing module 108 may extract the document image and associated data from the document database 120, including the user that uploaded the document, a user ID, the company ID that the document is for, the type of document that was uploaded, the image of the document, etc. The user ID may be a unique identifier, such as a unique number that is associated with the user. The company ID may be used to identify each company with a unique ID number. The company name may be the name of each company that is using the form. The form name may be the form that the company uses, for example, loan applications, medical records releases, retainer agreements, home sales contracts, employee expense reports, etc.

The image of the document may be stored as a data file on the extraction network 102 and may be an image that was scanned or taken by a device, such as a smartphone or tablet. In some embodiments, the database may include a form ID which may allow the extraction network 102 to identify the template that is required for the information extraction process. The extraction managing module 108 may determine, at step 204, the document type contained in the extracted document image from the document database 120. For example, the extraction managing module 108 may perform a model to detect and extract the document's title, such as the heading on the document's first page, to compare the document's title to the reference database 118 to extract the associated reference document. For example, the model may be an edge detection method in which the image edges are detected, such as Sobel or Canny edge detection techniques. The region of interest can be identified by analyzing the edges and looking for regions that contain text or other relevant information. The model may be a text detection method in which optical character recognition techniques may be used to detect the text in the image, and the region of interest may be identified by analyzing the location of the text.

In some embodiments, the extraction managing module 108 may send the document image to the region module 112 to extract the region of interest from the document image and then send the image to the text module 114 to extract the text from the document image and then compare the text to the reference database 118 and extract the reference with the same title as the document image that was extracted from the document database 120. The extraction managing module 108 may extract, at step 206, the reference document from the template database 118. For example, the extraction managing module 108 may perform a model to detect and extract the document's title, such as the heading on the document's first page, to compare the document's title to the reference database 118 to extract the associated reference document. For example, the model may be an edge detection method in which the image edges are detected, such as Sobel or Canny edge detection techniques. The region of interest can be identified by analyzing the edges and looking for regions that contain text or other relevant information. The model may be a text detection method in which optical character recognition techniques may be used to detect the text in the image, and the region of interest may be identified by analyzing the location of the text.

In some embodiments, the extraction managing module 108 may send the document image to the region module 112 to extract the region of interest from the document image and then send the image to the text module 114 to extract the text from the document image and then compare the text to the reference database 118 and extract the reference with the same title as the document image that was extracted from the document database 120. In some embodiments, the extraction managing module 108 may use the data extracted from the document database 120 to compare the data to the reference database 118 to extract the appropriate reference document. For example, the extraction managing module 108 may filter the reference database 118 on the company ID received from the document database 120 and then further filter the reference database 118 on the type of form that matches the type of form extracted from the document database 120 to extract the correct reference document from the reference database 118.

The extraction managing module 108 may send, at step 208, the document and the reference document to the alignment module 110. For example, the extraction managing module 108 may send the document image and reference document as well as the associated data that was extracted to the alignment module 110, such as the user that uploaded the document, a user ID, the company ID that the document is for, the type of document that was uploaded, the image of the document, etc. for the document image and may contain a company ID, a company name, a form name, a template document, and reference coordinates for the template for the reference document.

The extraction managing module 108 may initiate, at step 210, the alignment module 110. For example, the alignment module 110 may begin by being initiated by the extraction managing module 108. The alignment module 110 may receive the document and the reference document from the extraction managing module 108. The alignment module 110 may train the alignment machine-learning model. The alignment module 110 may deploy the alignment machine-learning model on the document. The alignment module 110 sends the image to the region module 112. The alignment module 110 returns to the extraction managing module 108.

The extraction managing module 108 may initiate, at step 212, the region module 112. For example, the region module 112 may begin by being initiated by the extraction managing module 108. The region module 112 may receive the image from the alignment module 110. The region module 112 may extract the reference coordinates from the template database 118. The region module 112 may compare the reference coordinates to the image. The region module 112 may extract the relevant information from the image. The region module 112 may store the relevant information in the region database 124. The region module 112 returns to the extraction managing module 108. The extraction managing module 108 may initiate, at step 214, the text module 114. For example, the text module 114 may begin by being initiated by the extraction managing module 108.

The text module 114 may extract the first information data entry from the region database 124. The text module 114 may deploy the text machine-learning model on the information data entry. The text module 114 may store the data in the information database 126. The text module 114 may determine if more information data entries are stored in the region database 124. If it is determined that more information data entries remain in the region database 124, the text module 114 may extract the next information data entry from the region database 124. The process returns to performing the text machine-learning model on the extracted information data entry. If it is determined that there are no more information data entries remaining in the region database 124, the text module 114 returns to the extraction managing module 108. The extraction managing module 108 may initiate, at step 216, the review module 116. For example, the review module 116 may begin by being initiated by the extraction managing module 108. The review module 116 may extract the first data entry from the information database 126. The review module 116 may display the text on the user interface 106. The review module 116 may determine if the user selected to translate the text. If it is determined that the user selected to translate the text, the review module 116 translates the text. The review module 116 may display the translated text on the user interface 106. If it is determined that the user did not select to translate or after the text has been translated and displayed on the user interface 106, the text in the review module 116 may determine if the user selected to edit the text.

If it is determined that the user selected to edit the text, the text module 116 may store the edits in the information database 126. If it is determined that the user did not select to edit the text, the text module 116 may determine if there are more data entries remaining in the information database 126. If it is determined that there are more data entries remaining in the information database 126, the text module 116 may extract the next data entry stored in the information database 126, and the process returns to displaying the text on the user interface 106. If it is determined that there are no more data entries remaining in the information database 126, the text module 116 returns to the extraction managing module 108.

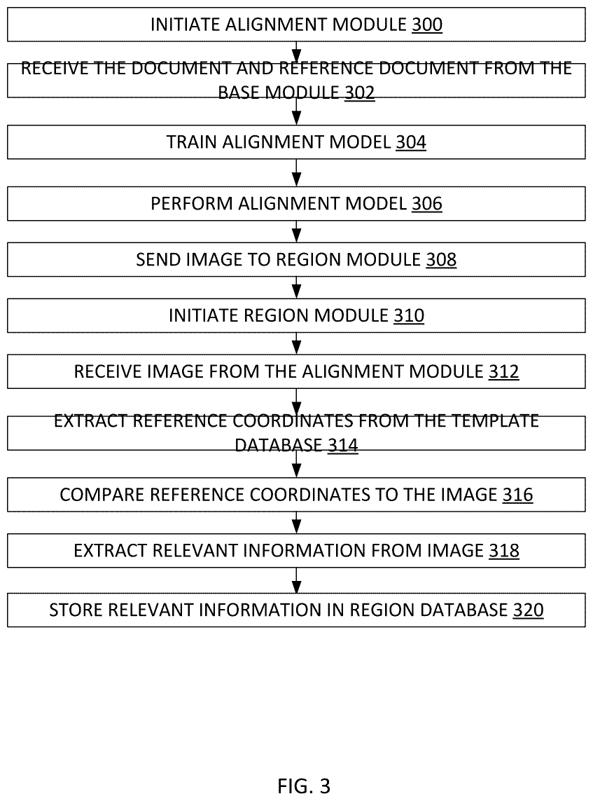

FIG. 3 illustrates an example workflow performed by the alignment module 110 and region module 112. The process may begin with the alignment module 110 being initiated, at step 300, by the extraction managing module 108. In some embodiments, the alignment module 110 may be continuously polling to receive the document and reference document from the extraction managing module 108 and may be initiated once the alignment module 110 may receive the document and reference document. The alignment module 110 may receive, at step 302, the document and the reference document from the extraction managing module 108. For example, the alignment module 110 may receive the document data from the extraction managing module 108, such as the user that uploaded the document, a user ID, the company ID that the document is for, the type of document that was uploaded, the image of the document, etc. The alignment module 110 may receive the reference document from the extraction managing module 108, such as the company ID, a company name, a form name, a template document, and reference coordinates for the template. In some implementations, no reference image may be available, and a grid image of Z×Z dimensions may be used (e.g., 50×50). Alignment may be performed by predicting the displacement flow of the input image by using the grid image in lieu of a reference image.

The alignment module 110 may train, at step 304, the alignment machine-learning model. For example, the alignment module 110 may train the alignment machine-learning model using data stored in the training database 122. For example, the alignment module 110 may extract patch embedding from the input image, and the patch embedding is inputted into a transformer encoder. The alignment module 110 may extract the patch embedding from the reference image, and the patch embedding is inputted into the transformer encoder. The alignment module 110 may add sinusoidal positional encoding to the input of the transformer encoder and decoder. For example, patch embedding may be a technique to convert an image into a sequence of fixed-length feature vectors, which may be processed by a deep neural network.

For example, patch embedding divides an image into small, non-overlapping patches and then applies a trainable linear projection to each patch to obtain a feature vector which can then be concatenated into a sequence that can be fed into a neural network. For example, sinusoidal positional encoding may be a technique that adds sinusoidal functions of different frequencies and phases to the input embeddings or feature maps to provide the model with information about the relative positions of different tokens or patches in the input sequence. For example, the input sequence may be a sequence of patches, and each patch is represented by a feature vector. The sinusoidal functions are added to the embeddings or feature maps before they are fed into a transformer encoder.

The representation from the transformer encoder may be passed through a decoder, and the output of the decoder may be passed through a linear layer to predict the displacement flow for each input pixel position. For example, the transformer encoder may take a sequence of input feature vectors, such as patch embeddings, and processes them to obtain a set of output feature vectors. The input sequence may represent a single image or a sequence of images. First, the transformer encoder may perform a multi-head attention operation which weighs the importance of different parts of the input sequence when encoding it. It calculates a set of attention weights for each clement in the input sequence by attending to all the other elements and then computes a weighted sum of the sequence elements based on these attention weights.

The result is a new feature vector set that captures the most important information in the input sequence. Then the transformer encoder may deploy a feedforward network operation that applies a linear transformation followed by a non-linear activation function to the multi-head self-attention operation's output, allowing the network to learn more complex relationships between the input sequence elements. For example, the transformer decoder may take an initial set of input feature vectors, such as patch embeddings, and generate a sequence of output feature vectors. The input sequence may represent an image or a sequence of images, and the output sequence may represent various attributes of the input, such as a displacement flow.

The transformer decoder may perform a masked multi-head self-attention operation, allowing the network to weigh the importance of different parts of the output sequence when decoding it. It calculates a set of attention weights for each element in the output sequence by attending to all the other elements. Unlike vanilla transformer decoder with triangular attention masks to mask the future sequence for displacement flow there is no such mask and all of the pixel displacement can be computed in parallel. The output of this operation is a set of feature vectors that capture the most important information for the current position in the output sequence. Then the transformer decoder may perform multi-head attention operations, allowing the network to weigh the importance of different parts of the input sequence when generating the output.

It calculates a set of attention weights for each element in the input sequence by attending to all the output elements up to the current position and then computes a weighted sum of the input sequence elements based on these attention weights. The output of this operation is a new set of feature vectors that capture the most important information from the input sequence for the current position in the output sequence. The transformer decoder may deploy a feedforwarded network operation which applies a linear transformation followed by a non-linear activation function to the output of the multi-head attention operation. This allows the network to learn more complex relationships between the input and output sequence elements. For example, the output feature map may be a set of feature vectors representing the network output.

The output feature map may result from applying a set of linear transformations and non-linear activation functions to the input feature vectors. For example, the linear layer may be a neural network layer that applies a linear transformation to the input feature vectors. A linear transformation is a mathematical operation that applies a set of weights to each input feature vector and sums the results to produce a single output value. For example, in a linear layer, the weights are represented by a matrix, and the input feature vectors are represented as a matrix where each row corresponds to a single feature vector. The linear transformation is then applied to the input matrix by matrix multiplication, followed by the addition of a bias term. The output of the linear layer is a new set of feature vectors that capture the linear relationship between the input features and the output.

These output feature vectors can be further processed by additional layers in the neural network to capture more complex relationships between the input and output. For example, the displacement flow may refer to the apparent motion of objects in a sequence of images which may be computed by tracking the movement of features or pixels. The resulting vector field represents the motion of objects in the scene and can be used for a variety of computer vision tasks, such as object tracking, motion estimation, and image segmentation. For example, the network may take two images as input and produce an output feature map representing the displacement flow between the two frames. In some embodiments, the model may be pretrained with a DVQA dataset which is fed learnable embedding as input to the decoder layer. The dataset is used for training and testing computer vision and question-answering models. The DVQA dataset for training the alignment machine-learning model consists for single page document containing letters, memos, notes, reports etc.

The outputs may be combined together into an HTML in which the document data is digitized for information extraction via query, as well as storage in association with the document. The format may be standardized for use with a variety of different types of documents, information contained therein, and queries. Large language models (LLMs) may be used as information extraction engines to extract information via query where by a query forms an instructions along the HTML document as input, and the output would be the required information to be extracted.

The alignment module 110 may deploy, at step 306, the alignment machine-learning model on the document. For example, the alignment module 110 downsamples the input image of size (1024×1024) to (256×256) and then predicts the displacement flow. For example, the alignment module 110 may extract patch embedding from the input image, and the patch embedding is inputted into a transformer encoder. The alignment module 110 may extract the patch embedding from the reference image, and the patch embedding is inputted into the transformer encoder. The alignment module 110 may add sinusoidal positional encoding to the input of the transformer encoder and decoder. For example, patch embedding may be a technique to convert an image into a sequence of fixed-length feature vectors, which may be processed by a deep neural network. For example, patch embedding divides an image into small, non-overlapping patches and then applies a trainable linear projection to each patch to obtain a feature vector which can then be concatenated into a sequence that can be fed into a neural network.

For example, sinusoidal positional encoding may be a technique that adds sinusoidal functions of different frequencies and phases to the input embeddings or feature maps to provide the model with information about the relative positions of different tokens or patches in the input sequence. For example, the input sequence may be a sequence of patches, and each patch is represented by a feature vector. The sinusoidal functions are added to the embeddings or feature maps before they are fed into a transformer encoder. The representation from the transformer encoder may be passed through a decoder, and the output of the decoder may be passed through a linear layer to predict the displacement flow for each input pixel position. For example, the transformer encoder may take a sequence of input feature vectors, such as patch embeddings, and processes them to obtain a set of output feature vectors.

The input sequence may represent a single image or a sequence of images. First, the transformer encoder may perform a multi-head attention operation which weighs the importance of different parts of the input sequence when encoding it. It calculates a set of attention weights for each element in the input sequence by attending to all the other elements in the sequence and then computes a weighted sum of the sequence elements based on these attention weights. The result is a new feature vector set that captures the most important information in the input sequence.

Then the transformer encoder may deploy a feedforward network operation that applies a linear transformation followed by a non-linear activation function to the multi-head self-attention operation's output, allowing the network to learn more complex relationships between the input sequence elements. For example, the transformer decoder may take an initial set of input feature vectors, such as patch embeddings, and generates a sequence of output feature vectors. The input sequence may represent an image or a sequence of images, and the output sequence may represent various attributes of the input, such as a caption or a segmentation mask.

The transformer decoder may perform a masked multi-head self-attention operation, allowing the network to weigh the importance of different parts of the output sequence when decoding it. It calculates a set of attention weights for each element in the output sequence by attending to all the other elements in the sequence up to the current position but not beyond. The masking ensures that the network does not cheat by using information from future positions in the output sequence. The output of this operation is a set of feature vectors that capture the most important information for the current position in the output sequence.

Then the transformer decoder may perform multi-head attention operations, allowing the network to weigh the importance of different parts of the input sequence when generating the output. It calculates a set of attention weights for each element in the input sequence by attending to all the output elements up to the current position and then computes a weighted sum of the input sequence elements based on these attention weights. The output of this operation is a new set of feature vectors that capture the most important information from the input sequence for the current position in the output sequence.

The transformer decoder may deploy a feedforwarded network operation which applies a linear transformation followed by a non-linear activation function to the output of the multi-head attention operation. This allows the network to learn more complex relationships between the input and output sequence elements. For example, the output feature map may be a set of feature vectors representing the network output. The output feature map may be the result of applying a set of linear transformations and non-linear activation functions to the input feature vectors. For example, the linear layer may be a type of neural network layer that applies a linear transformation to the input feature vectors. A linear transformation is a mathematical operation that applies a set of weights to each input feature vector and sums the results to produce a single output value. For example, in a linear layer, the weights are represented by a matrix, and the input feature vectors are represented as a matrix where each row corresponds to a single feature vector.

The linear transformation is then applied to the input matrix by matrix multiplication, followed by the addition of a bias term. The output of the linear layer is a new set of feature vectors that capture the linear relationship between the input features and the output. These output feature vectors can be further processed by additional layers in the neural network to capture more complex relationships between the input and output. For example, the displacement flow may refer to the apparent motion of objects in a sequence of images which may be computed by tracking the movement of features or pixels. The resulting vector field represents the motion of objects in the scene and can be used for a variety of computer vision tasks, such as object tracking, motion estimation, and image segmentation. For example, the network may take two images as input and produce an output feature map that represents the displacement flow between the two frames.

In some embodiments, the model may be pretrained with a DVQA dataset which is fed learnable embedding as input to the decoder layer. The dataset is used for training and testing computer vision and question-answering models. The DVQA dataset for training the alignment machine-learning model consists for single page document containing letters, memos, notes, reports etc. Then the alignment module 110 calculates the homography matrix using the displacement flow. For example, the homography matrix is a 3×3 matrix that describes the transformation between two planes in a 3D space. A homography matrix describes the perspective distortion between two images of the same scene taken from different viewpoints. It represents the transformation between the image plane of one view and the image plane of the other view, assuming a planar scene.

Then the alignment module 110 may transform the lower resolution standard coordinate point (0, 0), (0, 256), (256, 0), and (256, 256) using the homography matrix. The alignment module 110 linearly scales the lower resolution transformed coordinate point to a higher resolution coordinate point using the min-max normalization approach where old min value=0, old max value=255, new min value=0, and new max value=1023. For example, the min-max approach may be a data preprocessing technique used in machine learning and data science to scale numerical features to a specific range of values. For example, the original data values are transformed such that they fall within a specified range, typically between 0 and 1.

Then the alignment module 110 may estimate the homography matrix between standard higher-resolution coordinate points and transformed higher-resolution coordinate points. Once the estimated homography matrix is in higher resolution, the aligned image is outputted by unwarping the image. The alignment module 110 sends, at step 308, the image to the region module 112. For example, the alignment module 110 sends the image that is outputted by the alignment machine-learning model to the region module 112. The alignment module 110 returns, at step 310, to the extraction managing module 108.

The process with the region module 112 may be initiated by the extraction managing module 108. In some embodiments, the region module 112 may be continuously polling to receive the image from the alignment module 110, and once the image is received, the region module 112 is initiated. The region module 112 may receive, at step 312, the image from the alignment module 110. For example, the region module 112 may receive the image from the alignment module 110, which is the properly aligned document that was uploaded or stored on the extraction network 102 in the document database 120.

The region module 112 may extract, at step 314, the reference coordinates from the template database 118. For example, the region module may extract the reference coordinates from the template database 118 by receiving the type of document that was extracted from the document database 120 in the process described in the alignment module 110. For example, during document processing using the template with the reference coordinates, the document processing software may use these coordinates as reference points to identify and extract the data corresponding to specific fields or regions of the document. For example, if a template has reference coordinates for a customer's name and address, the document processing software can use these reference coordinates to locate and extract the corresponding data from the document. In some embodiments, the region module 112 may receive the reference document data from the alignment module 110.

The region module 112 may compare, at step 316, the reference coordinates to the image. For example, during document processing using the template with the reference coordinates, the document processing software may use these coordinates as reference points to identify and extract the data corresponding to specific fields or regions of the document. For example, if a template has reference coordinates for a customer's name and address, the document processing software can use these reference coordinates to locate and extract the corresponding data from the document. The region module 112 may extract, at step 318, the relevant information from the image. For example, the region module 112 may extract the data associated with reference points that correspond to a specific field or region.

The region module 112 may store, at step 320, the relevant information in the region database 124. For example, the region module 112 may store the extracted relevant information in the region database 124, such as the data associated with the reference points corresponding to the specific fields or regions on the document. For example, the region database 124 may contain the type of document, an ID for the document, the field or region of the document, the extracted data from the document, etc. In some embodiments, the database may contain the name or user ID of whose information is in the document, the name or user ID of the user that uploaded the document, the company ID or company name that the document is for, etc. The region module 112 returns to the extraction managing module 108.

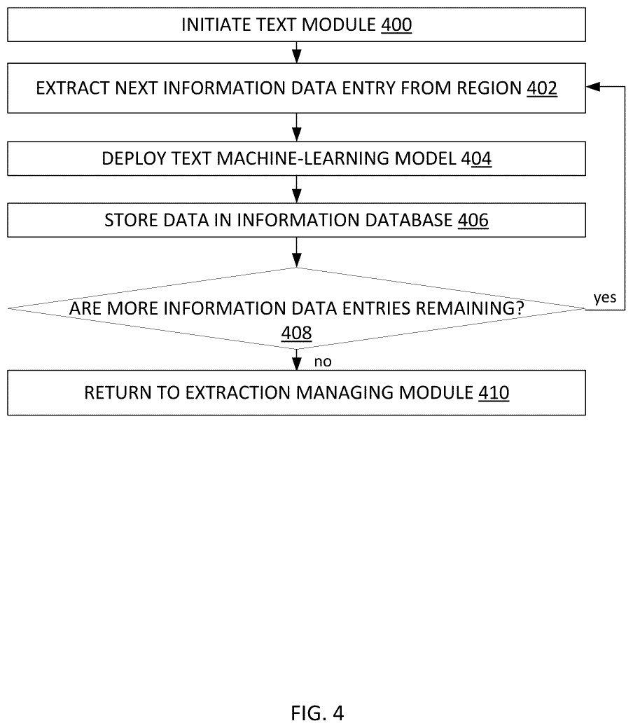

FIG. 4 illustrates an example workflow performed by the text module 114.

The process may begin with text module 114 being initiated, at step 400, by the extraction managing module 108. The text module 114 may extract, at step 402, the first information data entry from the region database 124. For example, the text module 114 may extract the first information data entry from the region database, such as the extracted data from the image from the process described in the region module 112. In some embodiments, the text module 114 may extract all of the information data entries associated with the whole document uploaded to the extraction network 102. The text module 114 may deploy, at step 404, the text machine-learning model on the information data entry.

For example, the information data entry may be the image of the region of interest extracted from the document image in the process described in the region module 112. The text machine-learning model may use a CNN encoder to extract the image feature sequence from the information data entry and is concatenated with a text sequence into a unified transformer to generate the next character and is continued until the end of the text token is detected. For example, a CNN encoder, or convolutional neural network encoder, may be a type of neural network that uses convolutional layers to learn spatially invariant features from image data, and an encoder may be a type of neural network that takes input data and may transform it into a lower-dimensional feature representation. The CNN encoder may consist of multiple convolutional layers followed by one or more fully connected layers. The convolutional layers use filters to extract features from the input image, and the fully connected layers are used to generate a fixed-length vector representation of the image. The output of the CNN encoder may be a feature map that represents the image in a lower-dimensional space. This feature map can be used as input to other neural network architectures.

The text module 114 may use a text decoding network in which the input is a sequence of encoded tokens, such as word embeddings or character encodings. The network may then process the input sequence through a series of recurrent or transformer layers, which capture the dependencies between the input tokens. The network may generate an output token at each time step, which may be the most likely token based on the current state of the network. The process may be repeated until the end-of-sentence token is generated, indicating that the network has completed its output sequence. The unified transformer may consist of a single set of transformer layers that can encode the input and output sequences. The unified transformer may consist of several self-attention and convolutional layers, followed by a decoder component that generates the output image. The self-attention layers capture the spatial and channel-wise dependencies within the input feature map, while the convolutional layers extract features at different spatial scales.

For example, character-based models may be used to generate text one character at a time instead of generating entire words or phrases. A character-based unified transformer typically consists of a stack of transformer layers that use self-attention to learn dependencies between characters in the input sequence. The model takes a sequence of input characters and generates a sequence of output characters, one character at a time. In some embodiments, the text machine-learning model may be trained using an IAM dataset which may be a dataset consisting of forms filled out by over 600 writers, with a total of over 115,000 isolated and labeled words. For example, supervised learning may be used to train the text machine-learning model, where the model is trained to predict the correct label, for example, the text, given an input image of handwriting.

For example, the training process may be preprocessing the images, such as normalizing the contrast, resizing the images to a standard size, and segmenting the images into individual words or text lines. The preprocessed images, such as a convolutional neural network, are then used to train the machine learning model. For example, the model may be presented with a batch of training images and corresponding labels. The model generates a prediction for each input image compared to the true label. The difference between the predicted and true label, the loss, is calculated, and the model weights are adjusted using backpropagation to minimize the loss. This process is repeated for many iterations over the entire training set until the model achieves satisfactory performance on a validation set.

In some embodiments, the text machine-learning model may be trained on a plurality of languages using similar datasets such as CEDAR, Chinese and English Document Analysis and Recognition, a dataset which contains handwritten Chinese and English characters and words, and printed text. RIMES, Repository of Images and MAnuscriptS, is a dataset which contains handwritten and printed text in several European languages, including French, German, and English. CVL, Chars74K, and Street View Text, a dataset which contains handwritten characters and digits from several languages, including English, French, German, and Italian. Arabic Handwriting Recognition Dataset, which contains handwritten Arabic text. Hindi Handwriting Dataset, which contains handwritten Hindi characters and words.

The text module 114 may store, at step 406, the data in the information database 126. For example, the output of the text machine-learning model which may be the key-value pair for the text and the associated translation of the text. For example, the key value pair may be a fundamental data structure consisting of a unique identifier, the key, and an associated value. The key serves as a reference to the value, allowing it to be easily retrieved or updated. Key-value pairs, such as databases and key-value may store, are commonly used in data storage and retrieval systems. The database may contain the text characters extracted from the image. The text characters may be in a plurality of languages for an individual document.

For example, the text machine-learning model can detect, recognize, and extract handwritten text in a plurality of languages contained in a single document image, and the extracted data may be stored in the information database 126. In some embodiments, the database may contain a document ID, user ID, company ID, etc., for the users of the extraction network 102 to extract the data stored in the information database 126. In some embodiments, the database may contain the plurality of texts for each of the documents that correspond to the region of interest the text was extracted from the document image.

The text module 114 may determine, at step 408, if more information data entries are stored in the region database 124. For example, the text module 114 continuously may extract the next information data entry from the region database 122 until all of the regions of interest that have been stored in the region database 122 have been processed by the text machine-learning model. In some embodiments, the text machine-learning model may process all of the data associated with one document image. Suppose it is determined that more information data entries remain in the region database 124 the text module 114 may extract at step 410. In that case, the next information data entry from the region database 124, and the process returns to performing the text machine-learning model on the extracted information data entry. If it is determined that there are no more information data entries remaining in the region database 124, the text module 114 may return to the extraction managing module 108.

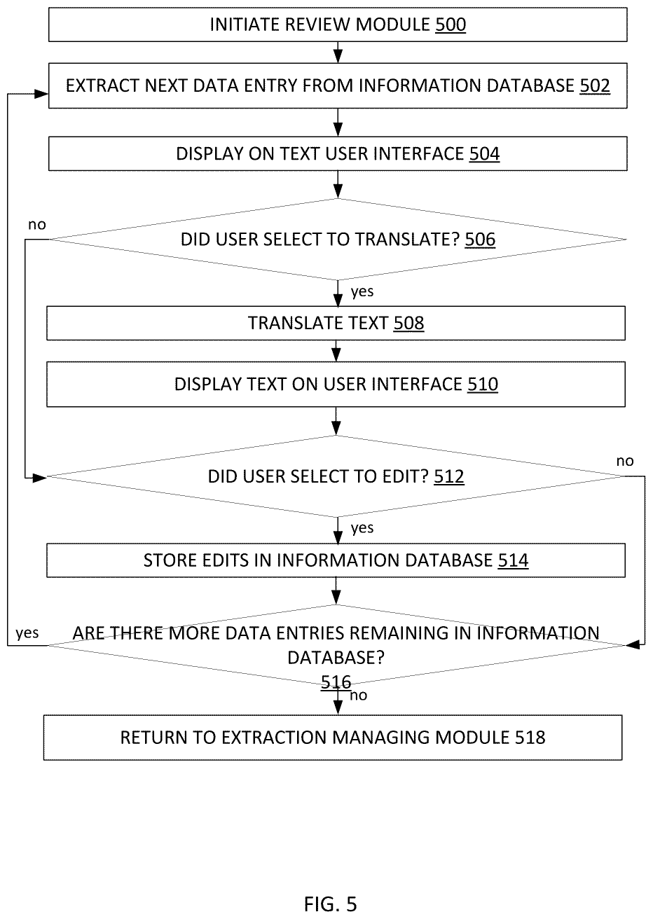

FIG. 5 illustrates an example workflow performed by the review module 116. The process may begin with the review module 116 being initiated, at step 500, by the extraction managing module 108. In some embodiments, the review module 116 may be initiated by a user of the extraction network 102. For example, the user may select a document that has been uploaded and processed to review for accuracy, and the review module 116 may be initiated. The review module 116 may extract, at step 502, the first data entry from the information database 126. For example, the review module 116 may extract the first data entry from the information database 126 for the document that was uploaded to the extraction network 102 and processed by the alignment module 110, region module 112, and text module 116. The data that is extracted may be the image of the region of interest from the uploaded document image and the extracted text from the text machine-learning model performed by the text module 116.

The review module 116 may display, at step 504, the text on the user interface 106. For example, the review module 116 may display the image of the region of interest from the uploaded document image and the outputted text from the text module 116 on the user interface 106. The review module 116 may determine, at step 506, if the user selected to translate the text. For example, the user may select to translate the text from one language to another on the user interface 106. If it is determined that the user selected to translate the text, the review module 116 translates, at step 508, the text. For example, the review module 116 may extract the associated text in the desired language from the information database 126.

In some embodiments, the review module 116 may perform a translation machine-learning process in which the input text is preprocessed to remove unnecessary characters, convert the text to lowercase, and split the text into sentences or paragraphs. The text is split into individual words or tokens, which are used as the input to the translation machine-learning model. A translation machine-learning model may be used to translate the source language text to the target language. The translation machine-learning may be performed through rule-based translation, statistical translation machine-learning, neural translation machine-learning, etc. The translated text is post-processed to correct any grammatical errors or inconsistencies and ensure that the translated text is fluent and natural-sounding in the target language.

The review module 116 may display, at step 510, the translated text on the user interface 106. For example, the review module 116 may display the translated text on the user interface 106, allowing the user to view the original text in the desired language. If it is determined that the user did not select to translate or after the text has been translated and displayed on the user interface 106, the text the review module 116 may determine, at step 512, if the user selected to edit the text. For example, the user may edit the displayed text to correct any errors or misspellings. If it is determined that the user selected to edit the text, the text module 116 may store, at step 514, the edits in the information database 126.

For example, if the user edits the text on the user interface 106, the edited text is stored in the information database 126 to ensure that the corrected information is saved on the extraction network 102. In some embodiments, the edited data may be stored in the training database 122 to further train the model, such as the text or translation machine-learning models. In some cases, the translation machine-learning model may be further trained and/or retrained based on received edits to update probability-weighted associations between inputs and outputs. If it is determined that the user did not select to edit the text, the text module 116 may determine, at step 516, if more data entries remain in the information database 126. If it is determined that more data entries remain in the information database 126, the text module 116 may extract, at step 518, the next data entry stored in the information database 126, and the process returns to displaying the text on the user interface 106. If it is determined that there are no more data entries remaining in the information database 126, the text module 116 returns, at step 520, to the extraction managing module 108.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

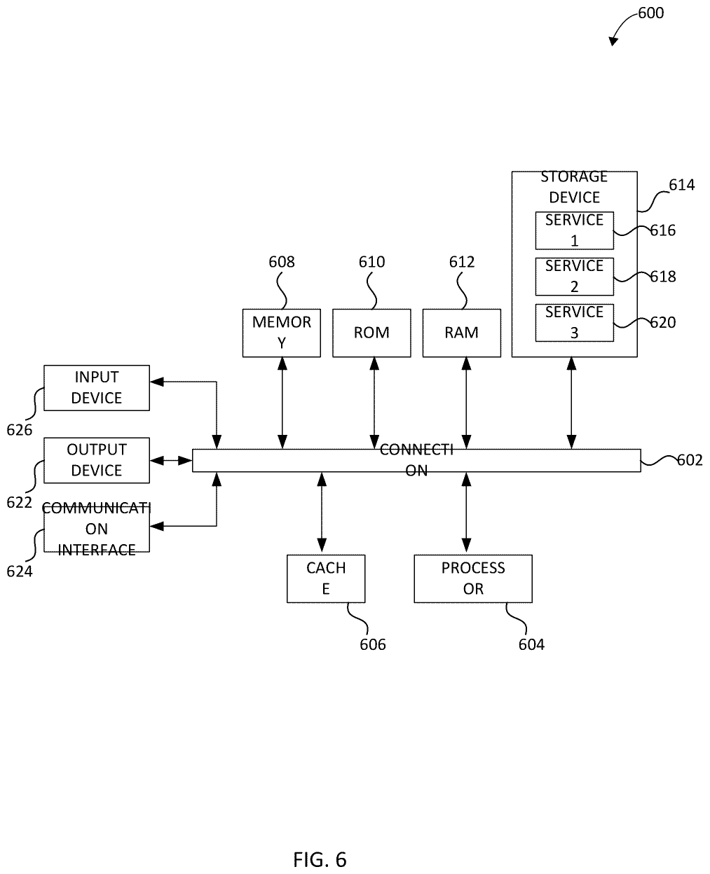

FIG. 6 shows an example of computing system 600, which can be for example any computing device making up education network 102, or any component thereof in which the components of the system are in communication with each other using connection 602. Connection 602 can be a physical connection via a bus, or a direct connection into processor 604, such as in a chipset architecture. Connection 602 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 600 includes at least one processing unit (CPU or processor) 604 and connection 602 that couples various system components including system memory 608, such as read-only memory (ROM) 610 and random access memory (RAM) 612 to processor 604. Computing system 600 can include a cache of high-speed memory 608 connected directly with, in close proximity to, or integrated as part of processor 604.

Processor 604 can include any general purpose processor and a hardware service or software service, such as services 606, 618, and 620 stored in storage device 614, configured to control processor 604 as well as a special-purpose processor where software instructions are incorporated into the actual processor design. Processor 604 may essentially be a completely self-contained computing system, containing multiple cores or processors, a bus, memory controller, cache, etc. A multi-core processor may be symmetric or asymmetric.

To enable user interaction, computing system 600 includes an input device 626, which can represent any number of input mechanisms, such as a microphone for speech, a touch-sensitive screen for gesture or graphical input, keyboard, mouse, motion input, speech, etc.

Computing system 600 can also include output device 622, which can be one or more of a number of output mechanisms known to those of skill in the art. In some instances, multimodal systems can enable a user to provide multiple types of input/output to communicate with computing system 600. Computing system 600 can include communication interface 624, which can generally govern and manage the user input and system output. There is no restriction on operating on any particular hardware arrangement, and therefore the basic features here may easily be substituted for improved hardware or firmware arrangements as they are developed.

Storage device 614 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 614 can include software services, servers, services, etc., that when the code that defines such software is executed by the processor 604, it causes the system to perform a function. In some embodiments, a hardware service that may deploy a particular function can include the software component stored in a computer-readable medium in connection with the hardware components, such as processor 604, connection 602, output device 622, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

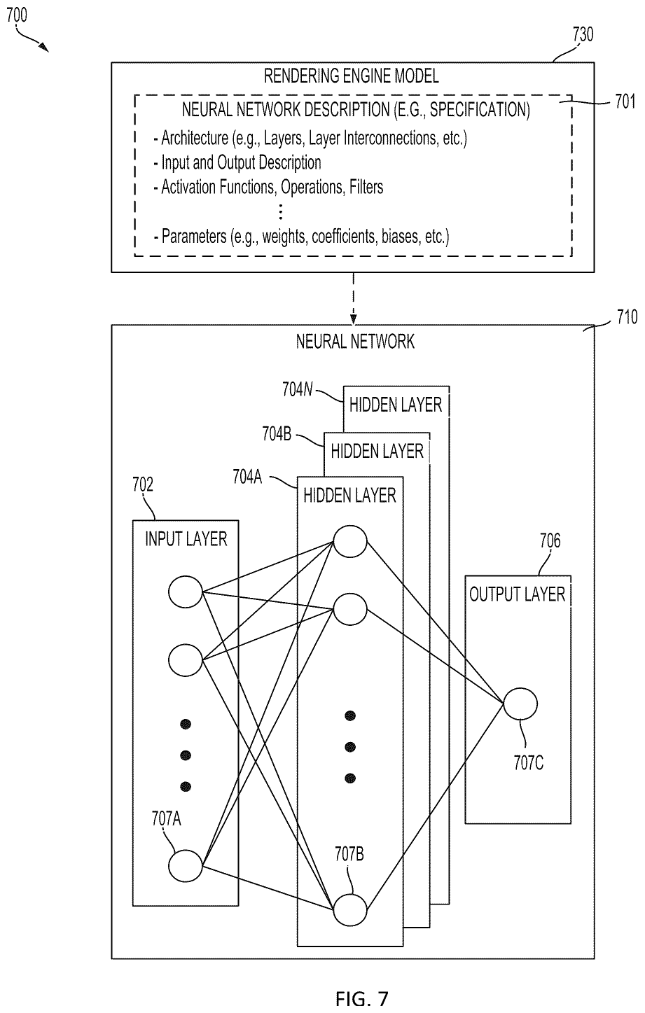

FIG. 7 illustrates an example neural network architecture. Architecture 700 includes a neural network 710 defined by an example neural network description 701 in rendering engine model (neural controller) 730. The neural network 710 can represent a neural network implementation of a rendering engine for rendering media data. The neural network description 701 can include a full specification of the neural network 710, including the neural network architecture 700. For example, the neural network description 701 can include a description or specification of the architecture 700 of the neural network 710 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 710 reflects the architecture 700 defined in the neural network description 701. In this example, the neural network 710 includes an input layer 702, which includes input data, such as extracted coursework progression data. In one illustrative example, the input layer 702 can include data representing a portion of the input media data such as a patch of data or pixels (e.g., extracted coursework progression data).

The neural network 710 includes hidden layers 704A through 704 N (collectively “804” hereinafter). The hidden layers 704 can include n number of hidden layers, where n is an integer greater than or equal to one. The number of hidden layers can include as many layers as needed for a desired processing outcome and/or rendering intent. The neural network 710 further includes an output layer 706 that provides an output (e.g., predicted status) resulting from the processing performed by the hidden layers 704. In one illustrative example, the output layer 706 can predict statuses.

The neural network 710 in this example is a multi-layer neural network of interconnected nodes. Each node can represent a piece of information. Information associated with the nodes is shared among the different layers and each layer retains information as information is processed. In some cases, the neural network 710 can include a feed-forward neural network, in which case there are no feedback connections where outputs of the neural network are fed back into itself. In other cases, the neural network 710 can include a recurrent neural network, which can have loops that allow information to be carried across nodes while reading in input.

Information can be exchanged between nodes through node-to-node interconnections between the various layers. Nodes of the input layer 702 can activate a set of nodes in the first hidden layer 704A. For example, as shown, each of the input nodes of the input layer 702 is connected to each of the nodes of the first hidden layer 704A. The nodes of the hidden layer 704A can transform the information of each input node by applying activation functions to the information. The information derived from the transformation can then be passed to and can activate the nodes of the next hidden layer (e.g., 704B), which can perform their own designated functions. Example functions include convolutional, up-sampling, data transformation, pooling, and/or any other suitable functions. The output of the hidden layer (e.g., 704B) can then activate nodes of the next hidden layer (e.g., 704 N), and so on. The output of the last hidden layer can activate one or more nodes of the output layer 706, at which point an output is provided. In some cases, while nodes (e.g., nodes 708A, 708B, 708C) in the neural network 710 are shown as having multiple output lines, a node has a single output and all lines shown as being output from a node represent the same output value.

In some cases, each node or interconnection between nodes can have a weight that is a set of parameters derived from training the neural network 710. For example, an interconnection between nodes can represent a piece of information learned about the interconnected nodes. The interconnection can have a numeric weight that can be tuned (e.g., based on a training dataset), allowing the neural network 710 to be adaptive to inputs and able to learn as more data is processed.

The neural network 710 can be pre-trained to process the features from the data in the input layer 702 using the different hidden layers 704 in order to provide the output through the output layer 706. In an example in which the neural network 710 is used to predict statuses, the neural network 710 can be trained using training data that includes historical coursework progression data and historical statuses. For instance, extracted coursework progression data can be input into the neural network 710, which can be processed by the neural network 710 to generate outputs which can be used to tune one or more aspects of the neural network 710, such as weights, biases, etc.

In some cases, the neural network 710 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 710, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 710 is unable to determine low level features and thus cannot make an accurate determination of what the classification of the object might be. A loss function can be used to analyze errors in the output. Any suitable loss function definition can be used.

The loss (or error) can be high for the first training dataset (e.g., extracted coursework progression data) since the actual values will be different than the predicted output. The goal of training is to minimize the amount of loss so that the predicted output comports with a target or ideal output. The neural network 710 can perform a backward pass by determining which inputs (weights) most contributed to the loss of the neural network 710, and can adjust the weights so that the loss decreases and is eventually minimized.

A derivative of the loss with respect to the weights can be computed to determine the weights that contributed most to the loss of the neural network 710. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 710 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 710 can represent any other neural or deep learning network, such as an autoencoder, a deep belief nets (DBNs), a recurrent neural networks (RNNs), etc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method for extracting information from document images, the method comprising:
applying an alignment machine-learning model to analyze a document inputted as an input image, wherein alignment machine-learning model outputs an unwarped version of the inputted document by predicting a displacement flow;
extracting reference coordinates associated with a reference document, wherein the reference coordinates include specific points or coordinates on the reference document that are used as reference points to identify and extract specific regions or fields of interest from the reference document;
comparing the reference coordinates with an image in the unwarped version of the inputted document;
extracting respective information from the image based on the reference coordinates;
inputting the extracted respective information in a handwritten format in a text machine-learning model that extracts digitally generated text in a plurality of languages; and
inputting the extracted text in a translation machine-learning model to output an associated translation of the extracted text.

2. The method of claim 1, further comprising:
extracting patch embedding from the input image; and
adding sinusoidal positioning encoding to the patch embedding to add sinusoidal functions of different frequencies and phases to the patch embedding to provide information about relative positions of different tokens or patches.

3. The method of claim 2, further comprising:
inputting the encoded patch embedding into a transformer neural network that processes a sequence of patch embeddings to obtain a set of feature vectors, wherein the transformer neural network includes an encoder and a decoder;
calculating, by the transformer neural network, a set of attention weights for each element in the set of feature vectors, wherein all pixel displacement is computed in parallel; and
passing the set of feature vectors through a linear layer that generates a sequence of output feature vectors that represents attributes of the inputted patch embeddings including the displacement flow for each input pixel position.

4. The method of claim 3, further comprising representing the sequence of output feature vectors as an output feature map based on application of a set of linear transformations and non-linear activation functions applied by a neural network layer of the transformer neural network.

5. The method of claim 4, further comprising:
calculating a homography matrix using the displacement flow, wherein the homography matrix describes a perspective distortion between two images of a same scene taken from different viewpoints;
transforming a lower resolution standard coordinate point using the homography matrix;
estimating the homography matrix between standard higher-resolution coordinate points and transformed higher-resolution coordinate points; and
outputting the aligned image by unwarping the image when the estimated homography matrix in higher resolution.

6. The method of claim 4, further comprising receiving two image layers, by additional layers in the transformer neural network, to produce the output feature map representing the displacement flow between the two image layers.

7. The method of claim 1, further comprising extracting, by a convolutional neural network (CNN) encoder of the text machine-learning model, an image feature sequence from the extracted respective information.

8. The method of claim 1, further comprising outputting a key-value pair for the extracted respective information and the associated translation text, wherein the key-value pair is a data structure that includes a unique identifier, a respective key, and an associated value.

9. The method of claim 1, further comprising:
receiving an edit to the associated translation of the extracted text; and
retraining the translation machine-learning model based on the received edit to update probability-weighted associations between inputs and outputs.

10. The method of claim 1, further comprising:
combining one or more outputs into a hypertext markup language (HTML) file;
storing the HTML file in association with the inputted document; and
retrieving data from the HTML file in response to a query.

11. The method of claim 10, wherein the HTML file includes a standardized format for use with one or more of different types of documents, data, and queries.

12. The method of claim 10, wherein the query includes an instruction input provided to a large language model (LLM), and wherein the LLM extracts information from the HTML file in accordance with the instruction input.

13. A system for extracting information from an image of a document, comprising;
one or more processors; and
a non-transitory computer-readable medium storing instructions that, when executed by the one or more processors, cause the one or more processors to:
apply an alignment machine-learning model to analyze a document inputted as an input image, wherein alignment machine-learning model outputs an unwarped version of the inputted document by predicting a displacement flow;
extract reference coordinates associated with a reference document, wherein the reference coordinates are specific points or coordinates on the reference document that are used as reference points to identify and extract specific regions or fields of interest from the reference document;
compare the reference coordinates with an image in the unwarped version of the inputted document;
extract respective information from the image based on the reference coordinates;
input the extracted respective information in a handwritten format in a text machine-learning model that extracts digitally generated text in a plurality of languages; and
input the extracted text in a translation machine-learning model to output an associated translation of the extracted text.

14. The system of claim 13, wherein the one or more processors are further caused to:
extract patch embedding from the input image; and
add sinusoidal positioning encoding to the patch embedding to add sinusoidal functions of different frequencies and phases to the patch embedding to provide information about relative positions of different tokens or patches.

15. The system of claim 14, wherein the one or more processors are further caused to:
input the encoded patch embedding into a transformer neural network that processes a sequence of patch embeddings to obtain a set of feature vectors, wherein the transformer neural network includes an encoder and a decoder;
calculate, by the transformer neural network, a set of attention weights for each element in the set of feature vectors, wherein all pixel displacement is computed in parallel; and
pass the set of feature vectors through a linear layer that generates a sequence of output feature vectors that represents attributes of the inputted patch embeddings including the displacement flow for each input pixel position.

16. The system of claim 15, wherein the one or more processors are further caused to represent the sequence of output feature vectors as an output feature map based on application of a set of linear transformations and non-linear activation functions applied by a neural network layer of the transformer neural network.

17. The system of claim 16, wherein the one or more processors are further caused to:
calculate a homography matrix using the displacement flow, wherein the homography matrix describes a perspective distortion between two images of a same scene taken from different viewpoints;
transform a lower resolution standard coordinate point using the homography matrix;
estimate the homography matrix between standard higher-resolution coordinate points and transformed higher-resolution coordinate points; and
output the aligned image by unwarping the image when the estimated homography matrix in higher resolution.

18. The system of claim 16, wherein the one or more processors are further caused to receive two image layers, by additional layers in the transformer neural network, to produce the output feature map representing the displacement flow between the two image layers.

19. The system of claim 13, wherein the one or more processors are further caused to extract, by a convolutional neural network (CNN) encoder of the text machine-learning model, an image feature sequence from the extracted respective information.

20. The system of claim 13, wherein the one or more processors are further caused to output a key-value pair for the extracted respective information and the associated translation text, and wherein the key-value pair is a data structure that includes a unique identifier, a respective key, and an associated value.

21. The system of claim 13, wherein the one or more processors are further caused to:
receive an edit to the associated translation of the extracted text; and
retrain the translation machine-learning model based on the received edit to update probability-weighted associations between inputs and outputs.

22. The system of claim 13, further comprising:
combining one or more outputs into a hypertext markup language (HTML) file;
storing the HTML file in association with the inputted document; and
retrieving data from the HTML file in response to a query.

23. The system of claim 22, wherein the HTML file includes a standardized format for use with one or more of different types of documents, data, and queries.

24. The system of claim 22, wherein the query includes an instruction input provided to a large language model (LLM), and wherein the LLM extracts information from the HTML file in accordance with the instruction input.

25. A non-transitory computer-readable medium comprising instructions, the instructions, when executed by a computing system, cause the computing system to:
applying an alignment machine-learning model to analyze a document inputted as an input image, wherein alignment machine-learning model outputs an unwarped version of the inputted document by predicting a displacement flow;
extracting reference coordinates associated with a reference document, wherein the reference coordinates include specific points or coordinates on the reference document that are used as reference points to identify and extract specific regions or fields of interest from the document;
comparing the reference coordinates with an image in the unwarped version of the inputted document;
extracting respective information from the image based on the reference coordinates;
inputting the extracted respective information in a handwritten format in a text machine-learning model that extracts digitally generated text in a plurality of languages; and
inputting the extracted text in a translation machine-learning model to output an associated translation of the extracted text.
